(19) United States
(12) Patent Application Publication
(10) Pub. No.: US 2007/0016434 A1
(43) Pub. Date: Jan. 18, 2007

(54) Interview-based enterprise planning

(75) Inventors: Leonard Roy Oppenheimer, St. Paul, MN (US); John M. Pitstick, Burnsville, MN (US)

Correspondence Address: SHUMAKER & SIEFFERT, P. A., 8425 SEASONS PARKWAY, SUITE 105, ST. PAUL, MN, 55125, US

(73) Assignee: Cognos Incorporated, Ottawa, ON (CA)

(21) Appl. No.: 11/191,793

(22) Filed: Jul. 28, 2005

Related U.S. Application Data
(60) Provisional application No. 60/699,794, filed on Jul. 15, 2005.

(51) Int. Cl. G06Q 99/00

(52) U.S. Cl. 705/1

(57) ABSTRACT

An enterprise planning system provides interview-based enterprise planning techniques that enable users to interact with a simple, manageable and understandable front-end for complex planning software. The interview-based enterprise planning system guides users through an enterprise planning process that captures the planning data with a set of ordered input screens that include an interview-based progression of an enterprise planning session. The interview-based enterprise planning system presents an interview-based question and answer planning process in which users enter input data through a combination of, for example, input fields, yes-no answers to interview questions, and drop-down boxes. The interview-based planning process may be customized on an organization wide basis, on a per plan basis, and/or on a per user basis.

This application claims the benefit of U.S. Provisional Application Ser. No. 60/699,794, filed Jul. 15, 2005, the entire content of which is incorporated herein by reference.

### TECHNICAL FIELD

The invention relates to enterprise computing environments, and more particularly, to computing environments for enterprise business planning.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligent tools, enterprise reporting tools, project and resource management systems and other enterprise software systems.

Many enterprise planning applications require a large population of users to enter data that the software then accumulates into higher level areas of responsibility in the organization. The system may perform mathematical calculations on the data, combining data submitted by one user with data submitted by another. Using the results of these calculations, the system may generate reports for review by higher management.

As enterprises become larger and more sophisticated, data accumulation and report generation can become very complex. A large number of users may be required to enter many different types of information into the system. For example, higher level management within the organization may identify fundamental business targets, such as average product price, cost per employee, sales targets, and the like, and push the targets down through the hierarchical structure of the corporation. At the same time, lower level management personnel at each cost center may be required to periodically make detailed sales forecasts or to forecast expenses and allocate the expenses to a number of categories, such as advertisement, travel, and salaries.

To collect this information, conventional systems typically present users with unstructured grid views or complex spreadsheet-like screens within which they are to enter their data. These mechanisms, however, are difficult to understand and use, and do not facilitate use by the wide variety of users that may be present in any given organization.

### SUMMARY

The invention is directed to enterprise planning techniques that improve the ease of use of complex planning software within large organizations. More specifically, interview-based enterprise planning techniques are described that enable users to interact with a simple, manageable and understandable front-end for complex planning software. The techniques facilitate involvement of more people in the planning process, yielding better accuracy, faster turnaround, and increasing ownership of the plan within the organization.

According to the techniques, an interview-based enterprise planning system guides users through an enterprise planning process that presents an ordered interview-based “question and answer” planning process. The interview-based enterprise planning system prompts users to enter input data through a sequence of ordered input screens. The input screens may present interview-based queries which the user answers via appropriate input areas including, for example, answers to yes-no queries, input fields and drop-down boxes. In addition, the interview-based planning process may be customized on an organization wide basis, on a per plan basis, for groups of users and plan elements (e.g., profit centers), and/or on a single user or plan element basis.

In one embodiment, a computing device comprises a multi-dimensional data store to store planning data for an enterprise planning session, and a user interface executing on the computing device that captures the planning data from a user for storage within the data store. The user interface captures the planning data with a set of ordered input screens that present an interview-based progression of an enterprise planning session.

In another embodiment, the user interface presents updated totals within the set of ordered input screens as the user provides the planning data throughout the enterprise planning session.

In another embodiment, each of the ordered input screens presents at least one input area to capture a respective portion of the enterprise planning data. The user interface may store the planning data captured by each of the input screens within the data store.

The invention may offer one or more advantages. For example, the techniques described herein may provide a simplified, easier to use planning process by enabling a wide variety of users to interact with a simple, manageable and understandable front-end for complex planning software. The invention may define an ordered sequence to an enterprise planning process, including data input, data movement, and metadata changes.

The invention may allow a customized planning process based on the needs or requirements of the organization, the user, and/or on the user's responses. The invention may provide a user with the ability to jump around within the ordered process, and to save and re-enter the ordered process at a later time. The system may further provide for validation of entries and ensure users have completed required fields within the planning process before continuing. The system may also provide for validation of user input values that do not match with desired planning targets. The interview-based enterprise planning system may also provide and display real-time calculated results based on the user's responses.

The details of one or more embodiments of the invention are set forth in the accompanying drawings and the description below. Other features and advantages of the invention will be apparent from the description and drawings, and from the claims.

### BRIEF DESCRIPTION OF DRAWINGS

FIG. 1 is a block diagram illustrating an enterprise planning environment in which an interview-based enterprise planning system may be used.

FIG. 2 is a block diagram illustrating one example embodiment of the enterprise planning system of FIG. 1.

FIG. 3 is a block diagram illustrating one example embodiment of a remote computing device with which a user interacts using interview-based enterprise planning.

FIG. 4 is a diagram illustrating the layout and content of an example user interface screen for an interview-based enterprise planning session.

FIGS. 5-10 illustrate a number of views presented by a user interface during an example interview-based enterprise planning session.

### DETAILED DESCRIPTION

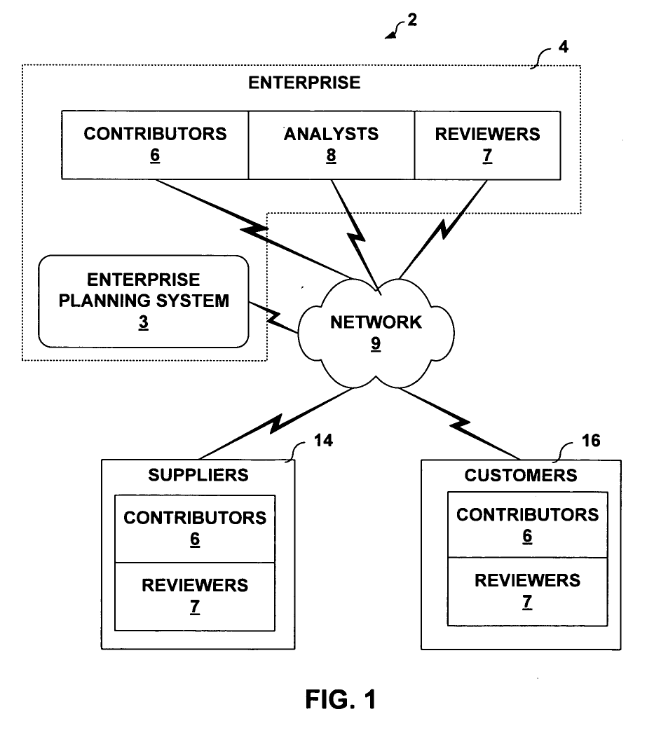

FIG. 1 is a block diagram illustrating an environment 2 in which an enterprise planning system 3 incorporates interview-based enterprise planning. Generally, enterprise planning system 3 provides three stages of enterprise planning: (1) a modeling stage, (2) a contribution stage, and (3) a reconciliation stage. In the modeling stage, analysts 8, such as the chief financial officer, senior financial analysts or product and sales analysts, define requirements and build planning models for the enterprise 4. More specifically, analysts 8 develop a model having a number of hierarchically arranged nodes representing various cost centers within enterprise 4, such as business units or departments.

During the modeling stage, analysts 8 also establish corporate targets for each node of the organizational hierarchy. Analysts 8 then assign one or more enterprise users to each node, such as managers, supervisors, sales representatives, lab managers, or the like, that are responsible for enterprise planning for the corresponding cost center. Each enterprise user may be designated as a contributor 6 that provides forecast planning data to enterprise system 3, a reviewer 7 that accepts or rejects contributions from contributors 6 or both. Contributors 6 and reviewers 7 may be authorized users within enterprise 4 or within other entities coupled to network 9, such as suppliers 14 and customers 16.

Finally, analysts 8 define a number of templates for collecting spending forecast data from the contributors. Analysts 8 include the corporate target data in the templates to facilitate reconciliation with the forecast data.

Next, enterprise planning system 3 enters the contribution phase during which contributors 6 interact with enterprise planning system 3 and input detailed forecasts in the form of contribution data. For example, contributors 6 may provide detailed financial forecasts, revenue forecasts, order forecasts, inventory forecasts, estimated resource requirements and the like, depending on the particular enterprise planning activity being carried out by enterprise 4. The system may also be used for other types of planning such as marketing campaign planning, retail outlet planning, or any other business planning activity. More specifically, contributors 6 provide contribution data via interaction with a customized interview-based enterprise planning process that guides them through an ordered sequence of input screens in which they enter contribution data. As described in further detail below, client computing device allow contributors 6 to engage in interview-based enterprise planning sessions to provide enterprise planning data for storage within one or more data stores. For purposes of the present invention, the enterprise planning data is stored in data stores having at least 3 dimensions. User interfaces provided by the computing devices capture the planning data within a set of ordered input screens that follow an ordered progression associated with the enterprise planning session. The input screens are ordered in the sense that they are presented in a sequence relevant to the particular business with which the enterprise planning system is to be used. In this way, each enterprise may develop its own customized interview-based planning sequence ordered in a way that makes sense for their business.

As each contributor 6 enters his or her contribution data during an interview-based enterprise planning session, system may automatically calculates and displays real-time updated results based on the interviewee's responses. The system may also provide for validation of entries and provide feedback to the interviewee concerning that validation.

During the reconciliation phase, enterprise planning system 3 automates the reconciliation of the forecast data with the corporate targets provided by analysts 8. In particular, enterprise planning system 3 operates in accordance with the defined model to provide a hierarchical planning process having multiple reconciliation levels. As each of contributors 6 provides his or her contribution data, enterprise planning system 3 may automatically aggregate the contribution data across enterprise 4 in real-time, and provides access to the aggregated data to reviewers 7 associated with higher levels of enterprise 4. In particular, upon receiving contribution data from contributors 6, enterprise planning system 3 identifies all higher levels of the organizational model affected by the newly received contribution data, and calculates new aggregate totals at each level in real-time.

Consequently, reviewers 7 view aggregated data across enterprise 4 in real-time during the enterprise planning session. At each level, enterprise planning system 3 ensures that reviewers 7, as defined by the nodes of the enterprise model, reconcile the target data with the forecast data. Each reviewer 7 may, for example, reject or accept the contribution data in view of corporate targets provided by analysts 8. This process continues until the contribution data is ultimately approved by the highest level of the organizational hierarchy, thereby ensuring that the contribution data from contributors 6 reconciles with corporate targets provided by analysts 8. If reviewers 7 also enter planning data, they may enter that data via an interview-based enterprise planning session as described herein.

In this manner, enterprise planning system 3 enables organizations to reconcile corporate models and organizational targets with detailed forecasts, and provides a platform that delivers collaborative, real-time planning capabilities, without requiring offline consolidation and aggregation of forecasts. The architecture of enterprise planning system 3 can readily scale to thousands of users. In addition, the interview-based enterprise planning system improves the ease of use of complex planning software within large organizations by enabling users to interact with a simple, more manageable and understandable front-end for complex planning software. The techniques facilitate use by both financial and non-financial users by presenting a series of understandable questions that relate directly to business decisions. Interview-based planning provides the ability to order and/or customize an enterprise planning process, including conditional pathways that allow decentralized user results to direct which parts of the planning process are relevant to their business needs. Interview-based enterprise planning is “friendlier” and less intimidating than a grid of numbers while providing the ability to add data and metadata. In addition, interview-based planning may allow a user to jump around within and re-enter an ordered planning process, provide for validation of entries, and may provide instant visibility to results of calculations and validations.

Enterprise users, such as contributors 6, analysts 8 and reviewers 7, may use a variety of computing devices to interact with enterprise planning system 3 via network 9. For example, an enterprise user may interact with enterprise planning system 3 using a laptop computer, desktop computer, or the like, running a web browser, such as Internet Explorer™ from Microsoft Corporation of Redmond, Wash.

In another embodiment, users may work off-line using an extended conventional spreadsheet software application such as Microsoft Excel™ provided by Microsoft Corporation, Quattro™ Pro of Corel and Lotus 1-2-3™ of IBM as described in copending and commonly assigned U.S. patent application Ser. No. 10/965,321, to Humenansky, et al., filed Oct. 14, 2004, which is incorporated herein by reference in its entirety. The functionality of spreadsheet application may be extended as described to provide enterprise users with the capability to view and edit multidimensional data, e.g., data located within a multidimensional data store maintained by enterprise planning system 3, in an electronic worksheet environment. This allows users to leverage existing spreadsheet functionality, e.g., formatting, graphing, and other functions, while interacting with a complex, multidimensional data store.

Alternatively, an enterprise user may use a personal digital assistant (PDA), such as a Palm™ organizer from Palm Inc. of Santa Clara, Calif., a web-enabled cellular phone or similar device. Network 9 represents any communication network, such as a packet-based digital network like the Internet. In this manner, system 2 can readily scale to suit large enterprises. The enterprise users may directly access enterprise planning system 3 via a local area network, or may remotely access enterprise planning system 3 via a virtual private network, remote dial-up, or similar remote access communication mechanism.

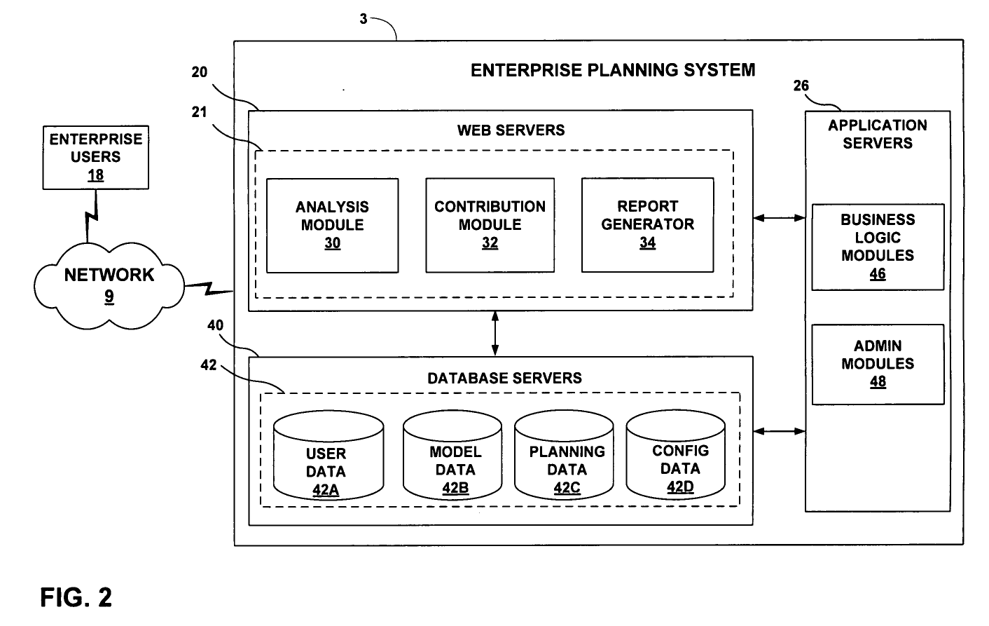

FIG. 2 is a block diagram illustrating one example embodiment of enterprise planning system 3. In the illustrated embodiment, enterprise planning system 3 includes web servers 20, application servers 26 and database servers 40.

Web servers 20 provide an interface for communicating with enterprise user 18 via network 9. Web servers 20 execute web server software, such as Internet Information Server™ from Microsoft Corporation, of Redmond, Wash. As such, web servers 20 provide an environment for interacting with contributors 6, analysts 8 and reviewers 7 according to software modules 21, which include analysis module 30, contribution module 32 and report generator 34.

Software modules 21 may comprise Lotus scripts, Java scripts, Java Applets, Active Server Pages, web pages written in hypertext markup language (HTML) or dynamic HTML, Active X objects, and other suitable modules. Web servers 20 serve up web pages defined by software modules 21, and communicate the web pages to computing devices of enterprise users 18. The web pages may include static media, such as text and graphic imagery, as well as conventional input media such as text entry boxes, radio buttons, drop-down menus and the like, for receiving information from enterprise users 18.

Software modules 21 interact with database servers 40 to access enterprise data 42 including user data 42A, model data 42B, planning data 42C, and configuration data 42D. Enterprise data may be stored in a number of different forms including one or more data storage files, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management system. Furthermore, although illustrated separately, enterprise data 42 could be combined into a single database or other data storage structure. Enterprise data 42 could, for example, be implemented as a single relational database, such as SQL Server from Microsoft Corporation.

User data 42A stores information for each of users 18, including the name, email address, and other contact information for the user. Model data 42B stores the enterprise planning models defined by the analysts 8. For example, model database 42B stores information that defines the reconciliation process developed by analysts 8, including the number of reconciliation levels, the various “nodes” in the hierarchy, and the contributor 6 associated with each node. In addition, model data 42B stores the respective data entry templates of the models for capturing contribution and review data from users 18. Planning data 42C stores the actual contribution data for each of the nodes for one or more planning sessions, and configuration (CONFIG) data 42D stores basic configuration data for enterprise planning system 3.

Application servers 26 provide an operating environment for execution of business logic modules 46, which provide functionality for accessing and processing the data stored within databases 42 in response to software modules 21. In particular, business logic modules 46 comprise software routines for implementing the enterprise planning functions, and are invoked by software modules 21. Application servers 26 may also provide an operating environment for execution of administration modules 48, which comprise software routines for carrying out various administrative tasks within the enterprise planning system 3.

Referring again to software applications 21, analysis module 30 includes one or more software modules for creating enterprise planning models, such as financial models for enterprise 4, to control the entire planning process. For example, analysis module 30 allows analysts 8 to define the various cost centers, the corresponding owners and the number of reconciliation stages in the enterprise planning process. In one configuration, analysis module 30 read cost-center structures and ownership from an enterprise resource planning (ERP) database (not shown). In addition, analysis module 30 allows analysts 8 to define the templates for collecting contribution data. A template may comprise one or more multi-dimensional data structures that provide an interface for entering and calculating contribution data. For example, the template may define cost centers as a dimension within a data store for selecting data, with a chart of accounts along the rows, and periods in the columns. Analysis module 30 stores the enterprise planning models, as well as the corresponding templates, within model data 42B.

Analysis module 30 also allows the organization to define a number of mechanisms for automating the budgeting process and ensuring that the contributors 6 submit their respective contribution data timely, and that templates quickly move through the defined reconciliation stages. For example, using analysis module 30, the analysts 8 can define timers for triggering electronic mail messages (emails) to remind the contributors 6 to access enterprise planning system 3 and complete a particular template.

Contribution module 32 include software modules for presenting the templates to enterprise users 18 designated as contributors 6, and for capturing contribution data from the contributors 5. In one embodiment, contribution module 32 includes software modules for presenting the interview-based enterprise planning process to a user 18 via a series of customized planning windows. In other embodiments, client-side software modules present the interview-based enterprise planning process.

In either case, the interview-based enterprise planning process enables users to interact with a simple, more manageable and understandable front-end for complex planning software. The interview-based enterprise planning process guides users through an enterprise planning process that is ordered and validated in which users enter input data through a combination of, for example, yes-no answers, tables and input fields. As a user provides contribution data, the software modules automatically update the contribution data across the enterprise in real-time, and presents real-time calculated results based on the user's responses. Contribution module 32 may capture and aggregate the contribution data across enterprise 4 in real-time, and provides access to the aggregated data to reviewers 7 associated with higher levels of enterprise 4.

Report generator 34 includes analytical software modules that generate enterprise planning reports based on the contribution data received from contributors 6 and stored within model data 42B. In particular, the analytical software modules allow users 18, such as analysts 8 and reviewers 7, to formulate complex queries for generating reports and performing other data analysis functions on the current data of the enterprise model. These software modules may be web-based modules having a browser interface, or may be stand-alone executable programs.

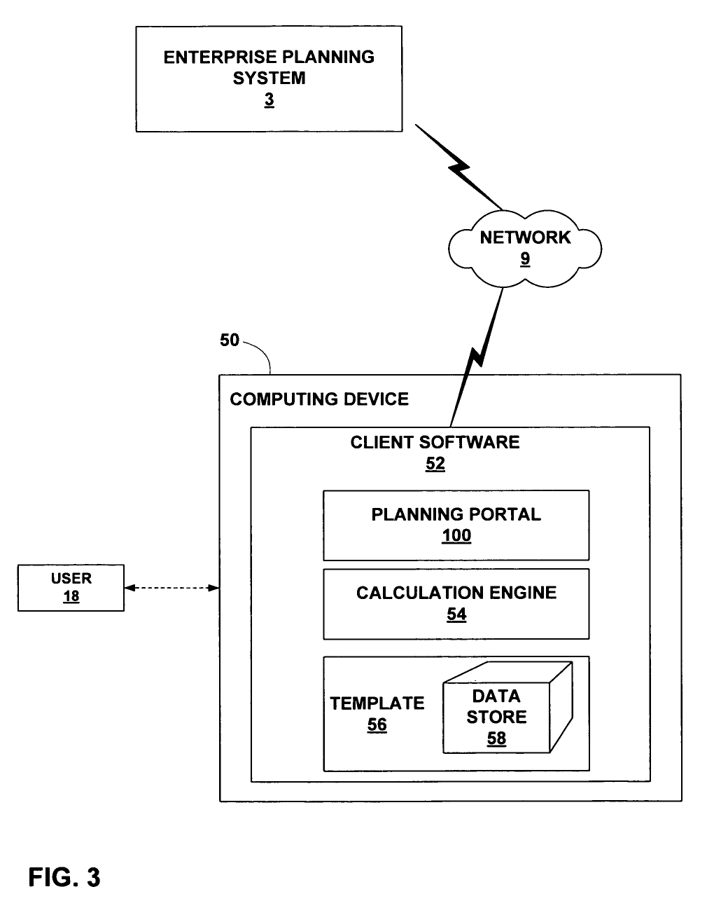

FIG. 3 is a block diagram illustrating one embodiment of a computing device 50, including various software modules executing thereon, when operated by a user 18, such as a contributor 6 or a reviewer 7. In the exemplary embodiment, computing device 50 includes client software 52, calculation engine 54, template 56 and data store 58. When a user 18 directs computing device 50 to access enterprise planning system 3, calculation engine 54, and template 56 are downloaded and installed within client software 52.

Enterprise planning system 3 may utilize a “cut-down” process by which the multidimensional data store is “sliced” for each user 18 in accordance with the defined enterprise model. During this process, enterprise planning system 3 identifies areas of the defined model to which users 18 are assigned, either as contributors or reviewers, and “slices” the data store based on the assignments. When a given user 18 logs in and proceeds with an enterprise planning activity, enterprise planning system 3 communicates the respective data slice to the respective computing device 50, where it is stored in data store 58. In this fashion, enterprise planning system 3 need not communicate the entire model to each of users 18, thereby reducing communication time as well as resource requirements. Instead, each user 18 only receives information relevant to their respective portion of the planning process.

To interact with enterprise planning system 3, each of contributors 6 uses client software 52, such as a web brower or other software module (e.g., a specialized spreadsheet application), to interact with template 56 to provide respective contribution data via the interview-based planning process. Each user 18 may also view the dynamic changes that occur as each new piece of information is input. Because calculation engine 54 is resident within client software 52, the cell entries do not have to be resubmitted to enterprise planning system 3, recalculated, and then re-posted to the client software 52 via network 9. If the contributor 6 wishes to end the planning session, but has not finished the process, the contributor 6 can save template 56 to the data store 58, and/or save it back to enterprise planning system 3. In this way, contributor 6 has the ability to save their work locally and work off-line or come back to their work at a later time, as well as save their work to the central server if desired. When the contributor 6 wishes to continue the planning session, he or she can access enterprise planning system 3, at which time the appropriate template 56 and data store 58 will be loaded in client software 52 for further editing. When the contributor 6 completes the interview-based planning process, the contributor 6 can submit the data to enterprise planning system 3, where it may then be aggregated across enterprise 4 and viewed by reviewers 7 and/or analysts 8 associated with higher levels of enterprise 4.

In similar fashion, each of reviewers 7 interacts with enterprise systems 3 via client software 52 executing upon his or her remote computing device 50. Each reviewer 7 may reject or accept the contribution data in view of corporate targets provided by the analysts 8. This process continues until the contribution data is ultimately approved by the reviewers associated with the highest level of the organizational hierarchy, thereby ensuring that the contribution data from the contributors reconciles with corporate targets.

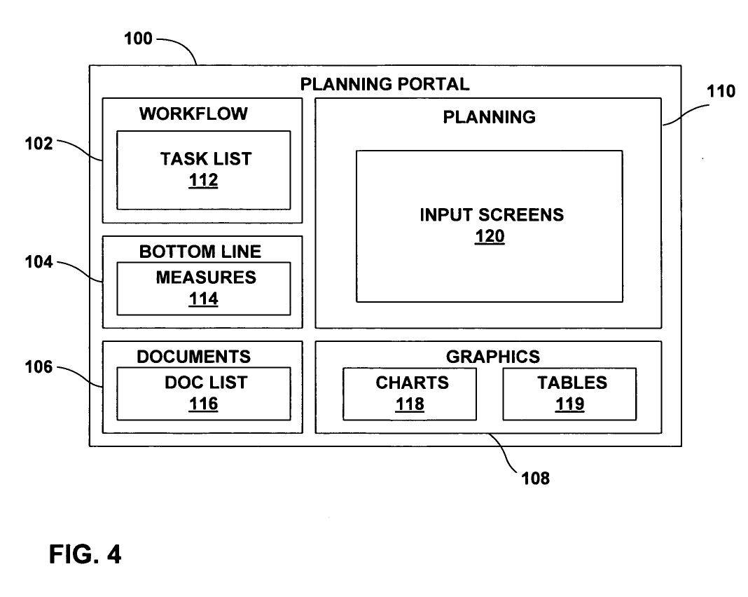

FIG. 4 shows a diagram illustrating the layout and content of an example user interface presented by interview-based enterprise planning system 3. The user interface presents a planning portal 100 through which a user interacts with enterprise planning system 3. Planning portal 100 may include several windows, such as a workflow window 102, a bottom line window 104, a document window 106, a planning/data entry window 110 and/or a graphics window 108. Planning portal 100 captures planning data with a set of ordered input screens that include an interview-based progression for an enterprise planning session. In other words, planning portal 100 presents an interview-based enterprise planning session that guides a user step-by-step through an ordered planning process.

The interview-based planning process includes simple, easy to understand questions sorted into planning categories appropriate for the particular business and/or the particular user. These categories are embodied as a task list 112 presented in workflow window 102. Interview-based planning system 3 may automatically guide the user through the task list in a defined order, or, the user may jump around within the task list by clicking on a desired task.

As the interview-based planning process proceeds through task list 112, a series of corresponding ordered input screens 120 appear in planning window 110. Each task has a corresponding series of input screens 120. These input screens 120 prompt the user, via an interview-based methodology, to enter the appropriate planning data for the current task. Each of the ordered input screens 120 presented in planning window 110 includes at least one input area to receive answers to yes/no queries or to capture a respective portion of the enterprise planning data. The user interface stores the planning data captured by each of the input screens within the data store 58. In addition, planning portal 100 may present updated totals as the user provides the planning data throughout the course of the enterprise planning session. Document window 106 may also display a list of documents 116 which may be of interest to the user during the interview-based enterprise planning session.

The particular input screen(s) 120 displayed in planning window 110 may vary depending upon the current task (indicated with highlight in task list 112). The input screens 120 may include, for example, an interview-based planning sequence in which a user inputs planning data via a set of input screens that follow an ordered progression of an enterprise planning session. The interview-based input screens may accept data using a combination of input fields, answers to yes/no queries, drop-down boxes, and the like. As the user inputs planning data in response to the interview-based queries, the interview-based planning system automatically enters the input into the appropriate storage area within multi-dimensional data store 58.

As the user provides the planning data throughout the course of the interview-based planning session, interview-based planning system 3 may also automatically apply calculations to the newly entered planning data to calculate and present updated totals within the planning portal 100. These calculations may be applied locally in real-time and presented in bottom line window 104 and/or graphics window 108. In this way, bottom line window 104 may reflect up-to-date numbers for specified measures 114. The updated information may also be displayed in graphics window 108 as charts 118, tables 119 or other appropriate formats. Interview-based enterprise planning system 3 may thus provide instant feedback of results of calculations and validations.

Planning portals 100 may be defined on a global (all plans) basis such that the window layout, workflow, interview sequence, access and/or functionality of planning portals 100 are common among all plans, or may be defined such that these elements are specific to individual plans. In addition, planning portals 100 may be defined and/or customized on a per user (or user type) basis, including user-specific interview sequences in planning window 110, task lists 112 in workflow window 102, document lists 116 in document window 106, measures 114 in bottom line window 104 and/or charts 118 and/or tables 119 in graphics window 108. The granularity with which planning portals 100 are set up during the modeling stage may vary depending upon the particular business or businesses involved, the requirements of those businesses, and the functionality required by the users within those businesses. Again, the planning portals may be customized based on an expected and understandable business sequence that is ordered in a way that is relevant for each particular business.

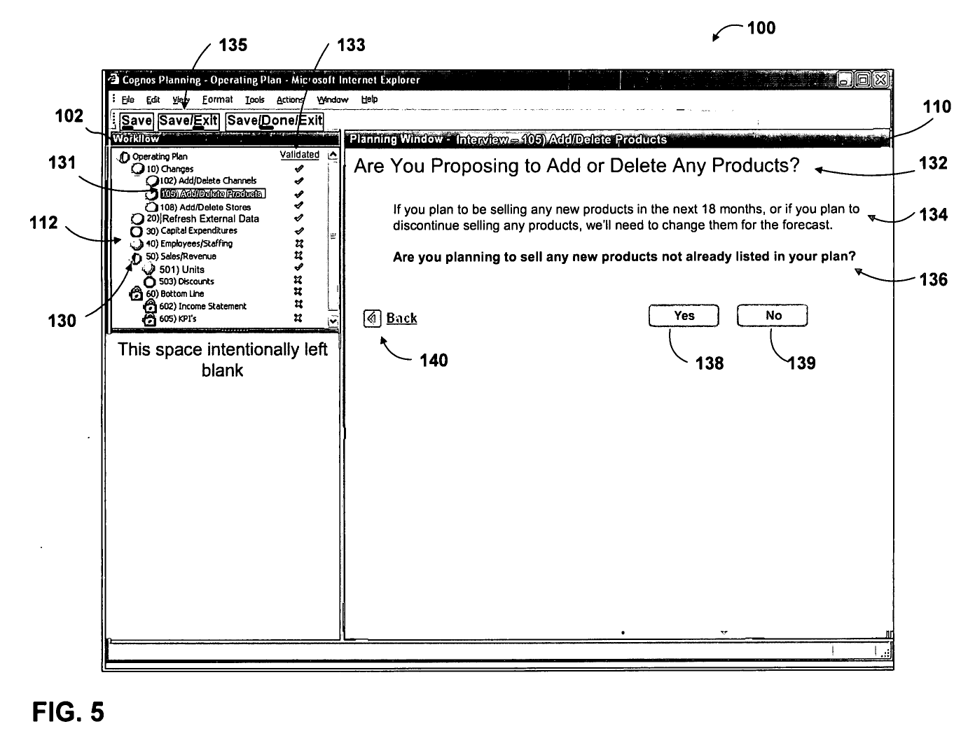

FIGS. 5-10 illustrate a number of views of a planning portal 100 displayed by client software 52 during an exemplary interview-based enterprise planning session. In this example, workflow window 102 includes a task list 112 which sorts the overall workflow into planning categories, or “tasks.” For example, FIG. 5 illustrates one embodiment of a planning portal 100 in which the current task “Add/Delete Products” 131 within task list 112 of workflow window 102 is highlighted. Each task in task list 112 may have one several possible workflow states indicated by icons such as icon 130. These icons may indicate whether the task has not yet been started, the task is a “work in progress” or the task is locked (in other words, the owner has submitted the data for review).

Each task within task list 112 has a corresponding customized series of input screens 120 that are displayed in planning window 110. At the onset of each task, the first input screen for that task is illustrated. Then, the ordered sequence of input screens presenting the appropriate interview-based queries, grids or spreadsheets for each task are presented until all required planning data for that task has been entered.

Input screen 120 within planning window 110 of FIG. 5, for example, displays an example interview heading “Are you proposing to Add or Delete Any Products?” 132, which in this example corresponds to the first input screen for task “Add/Delete Products” 131. Input screen 120 further includes explanatory material 134, interview query 136, yes/no buttons 138 and 139, respectively, and back button 140. Tabs 135 allow a user to save planning data entered at any point, save and exit for completion of the interview-based planning process at a later time, or save, submit and exit when the interview-based planning process is completed.

In one embodiment, a validation column 133 provides visual indication as to whether each task in task list 112 has been “validated.” Whether a particular task is marked as “validated” may be based on a combination of several factors, depending upon the task. For example, marking a task as “validated” may be based on whether a particular task is required or optional for that particular user, whether the user has actually completed the task, and/or whether the planning data entered by the user meets the expectations as set by the analysts during the modeling stage. Validation column 133 provides the user with affirmative feedback as to whether a task requires completion, whether it has been completed and/or whether the users data satisfies the financial goals of the organization.

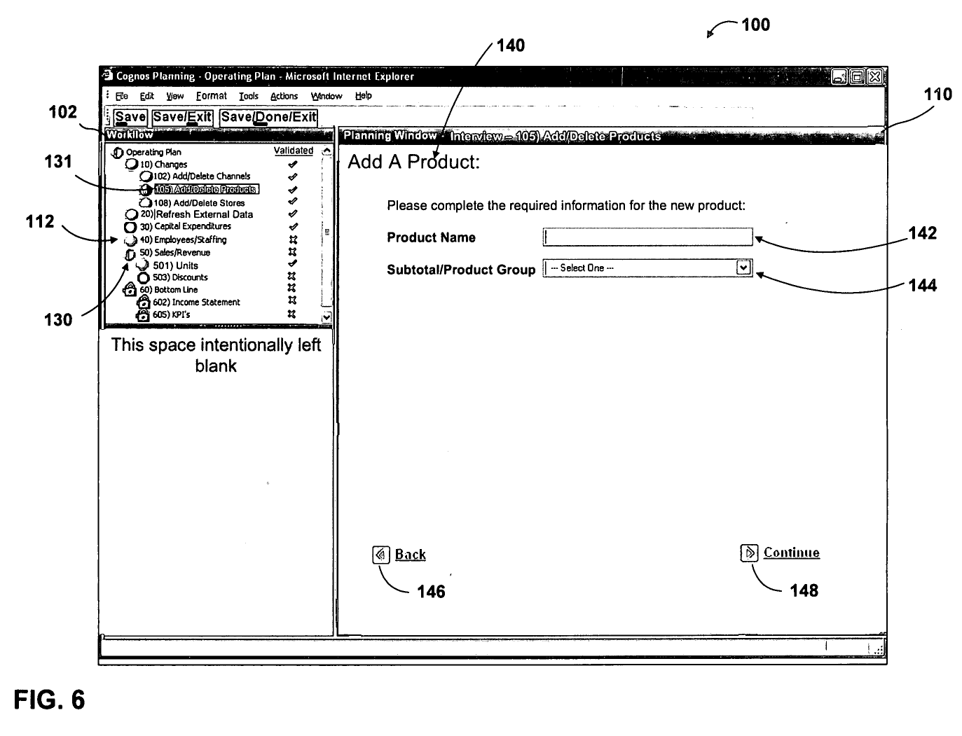

FIG. 6 illustrates one embodiment of a planning portal 100 displayed by client software 52 after a user selects “Yes” button 128 in the planning window 110 of FIG. 5. Planning window 110 of FIG. 6 includes interview heading 140, input field 142, drop-down box 144, back button 146 and continue button 148. FIG. 6 illustrates a sequential presentation of an interview-based planning sequence, and shows one example of how the interview may be customized based on the user's previous responses. For example, if the user had selected “No” button 129 in FIG. 5, interview-based enterprise planning system 3 would not have presented the input screen of FIG. 6.

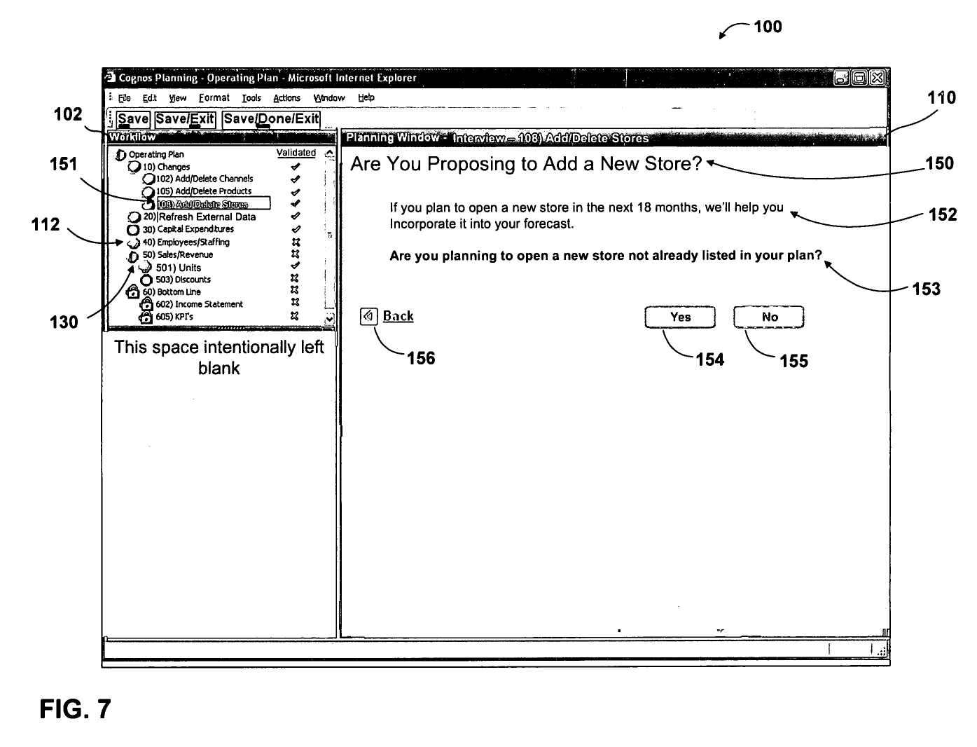

FIG. 7 illustrates one embodiment of a planning portal 100 displayed by client software 52 in which the current task is “Add/Delete Stores” 151 in workflow window 102. In this planning portal 100, planning window 110 displays an example interview heading “Are you proposing to Add as New Store?” 150. Planning window 110 further includes explanatory material 152, interview query 153, Yes/No buttons 154 and 155, respectively, and back button 166.

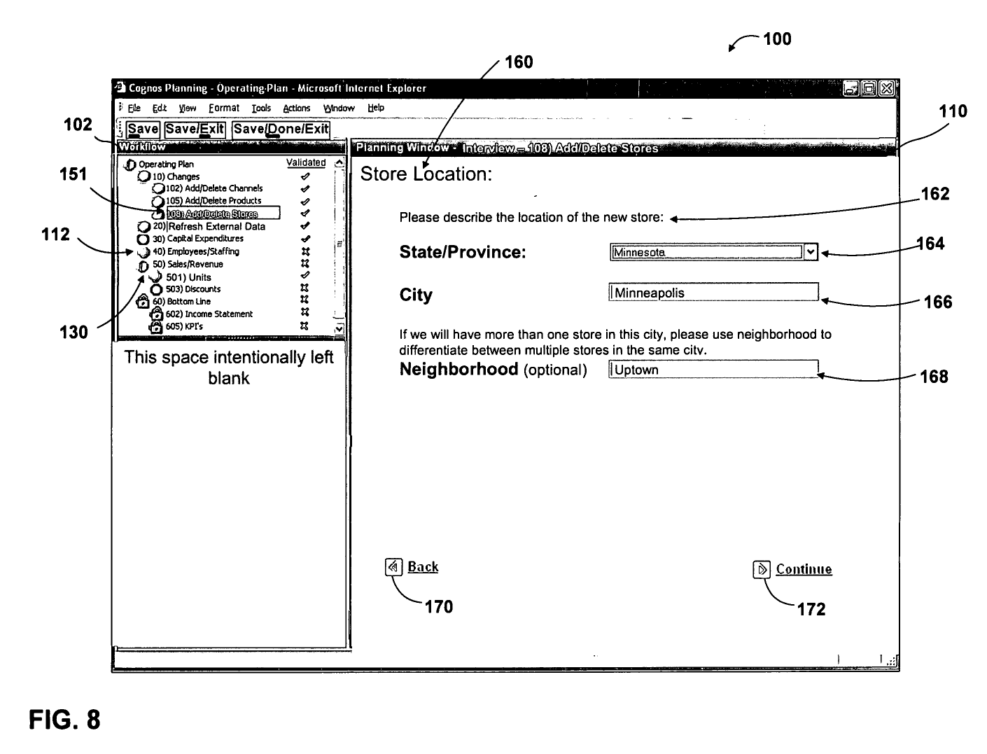

FIG. 8 illustrates one embodiment of a planning portal 100 displayed by client software 52 after a user selected “Yes” button 154 in the planning window 110 shown in FIG. 7. Planning window 110 of FIG. 8 includes interview heading 160, explanatory material 162, input fields 166 and 168, drop-down box 164, back button 170 and continue button 172.

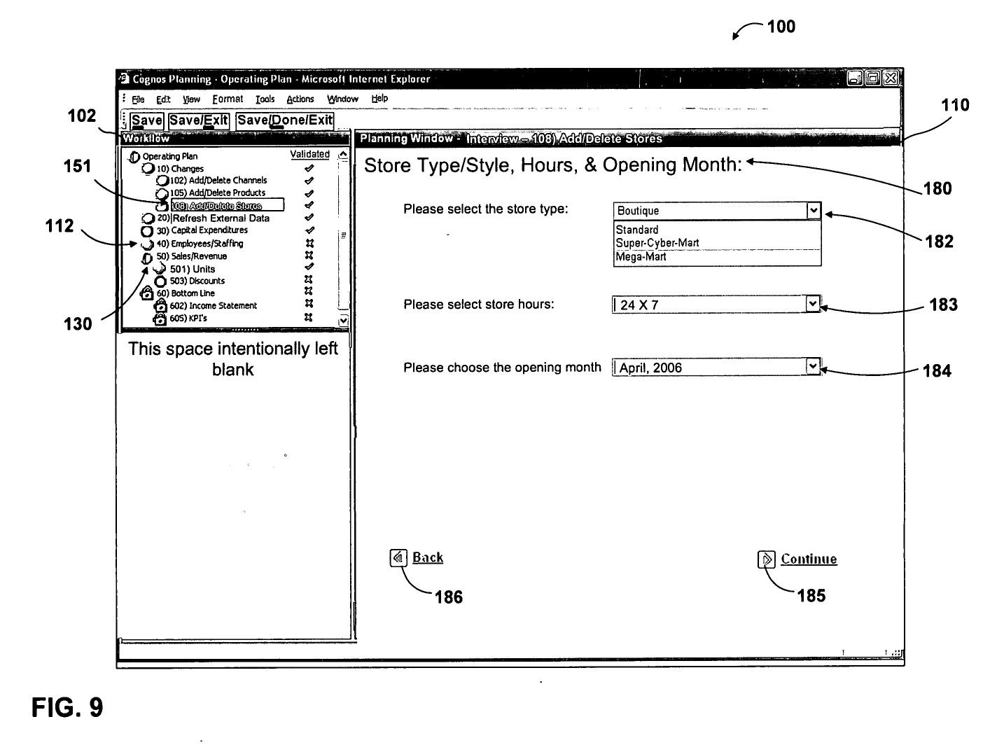

FIG. 9 illustrates one embodiment of a planning portal 100 displayed by client software 52 in which the user answers further interview-based queries for task “Add/Delete Stores” 151. Planning window 110 of FIG. 9 includes interview heading 180, drop-down boxes 182, 183 and 184, back button 186 and continue button 185.

FIGS. 7-9 illustrate another example of how the interview-based planning system 3 may customize the interview-based planning session based on the user's prior responses. For example, if in FIG. 7 the user had selected “No” button 155, the interview-based planning process would not present the interview queries shown in FIGS. 8 and 9 because they are relevant only if the user selects “Yes” button 134 in FIG. 7.

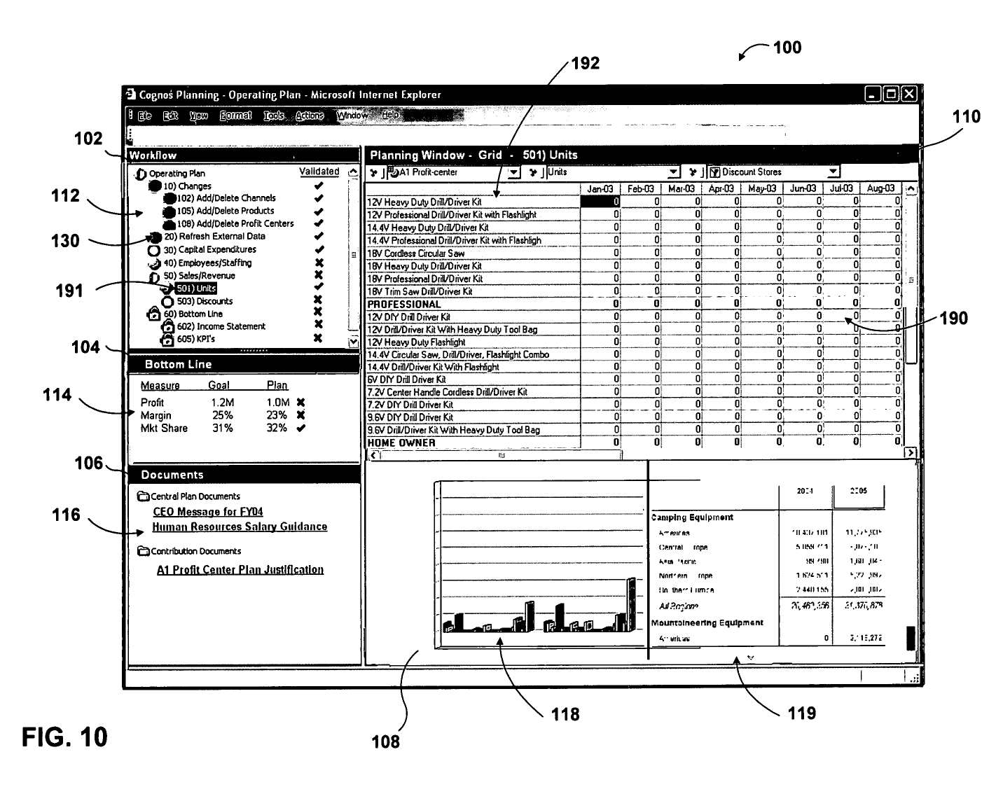

FIG. 10 illustrates one embodiment of a planning portal 100 displayed by client software 52 in which the current task is “Units” 131 in task list 112. In the embodiment shown in FIG. 10, planning window 110 displays an example grid or spreadsheet including an itemized list 192 and a grid of input cells 190 in which a user may input planning data in the form of detailed financial forecast data. It shall be understood, however, that this is but one example of the type of information which may be presented in a planning portal, and that the information presented may vary depending upon the business involved and/or throughout various stages of the enterprise planning process.

Interview-based enterprise planning system 3 may automatically perform calculations on the data in data store 58 as interview-based questions are answered or data is entered into grid 190 to arrive at updated planning data. Updated information for relevant measures 114 such as profit, margin, market share, or other key metrics, financial or otherwise, may be displayed in real-time in bottom line window 104. The updated information may also be displayed in graphics window 108 in the form of charts 118, tables 119 or other appropriate formats. Document window 106 may include a list of documents 116 which may be of interest to the user during the interview-based planning process.

FIGS. 5-10 illustrate the interview-based queries of the type which may be presented throughout the interview-based enterprise planning process. Simple, understandable questions and additional explanatory material designed to assist the user in answering the query are presented to the user as they progress through the interview-based enterprise planning session. In addition, easily understood input areas, such as yes/no buttons, input fields and drop down boxes assist the user in entering planning data in a more easily understandable form.

FIGS. 5-10 illustrate but a few of many ways in which an interview-based planning session may be displayed. It shall be understood that the layout, appearance, sequence of interview queries, input fields, yes/no inputs, drop-down boxes, tables, grids, spreadsheets, etc., may all vary depending upon the particular type of business, the particular type of user to which the interview-based planning session is directed, and/or may also vary throughout a particular enterprise planning process. Many different embodiments may therefore be possible and the present invention is not limited in this respect.

Interview-based enterprise planning system 3 may automatically lead the user through the task list in an ordered progression until all required planning data for each task list has been entered. Alternatively, interview-based enterprise planning system 3 may provide the user with the ability to jump around within the ordered process. For example, the user may click on any one of tasks in task list 112 to go directly to the corresponding input screens for that task. Further, interview-based planning system 3 may also allow a user to save and re-enter the ordered process in the same place where they left off at a later time.

Various embodiments of the invention have been described. These and other embodiments are within the scope of the following claims.

1. A computing system comprising:
a multi-dimensional data store to store planning data for an enterprise planning session; and
a user interface executing on the computing system that captures the planning data from a user for storage within the data store,
wherein the user interface captures the planning data with a set of ordered input screens that present an interview-based progression of an enterprise planning session.

2. The computing system of claim 1, wherein the user interface presents updated totals as the user provides the planning data throughout the enterprise planning session.

3. The computing system of claim 1,
wherein each of the ordered input screens presents at least one input area to capture a respective portion of the planning data, and
wherein the user interface stores the captured planning data within the data store to form multi-dimensional planning data.

4. The computing system of claim 3, wherein the input area includes at least one of input fields, yes/no answers to interview queries, or drop-down boxes.

5. The computing system of claim 3, wherein the input area includes at least one of a grid or a spreadsheet.

6. The computing system of claim 1, wherein the user interface includes a bottom line window that presents updated totals for defined measures as the user provides the planning data throughout the enterprise planning session.

7. The computing system of claim 6, wherein the defined measures include at least one of profit, margin, and market share.

8. The computing system of claim 1, wherein the user interface includes a document window that presents a list of documents relevant to the enterprise planning session.

9. The computing system of claim 1, wherein the user interface presents at least one of a chart or a table indicative of updated totals as the user provides the planning data throughout the enterprise planning session.

10. The computing system of claim 1, wherein the user interface includes a workflow window.

11. The computing system of claim 6, wherein the workflow window includes a task list that sorts the workflow into planning categories.

12. The computing system of claim 11, wherein the workflow window includes a validation column that marks whether each task in the task list is validated.

13. The computing system of claim 11, wherein each task in the task list has a corresponding set of ordered input screens.

14. The computing system of claim 11, wherein the user selects a desired task from the task list.

15. The computing system of claim 1, wherein the user saves captured planning data and re-enter the enterprise planning session at a later time.

16. The computing system of claim 1, wherein the set of ordered input screens is customized based on the user's previous responses.

17. The computing system of claim 1, wherein the system automatically leads the user through the ordered input screens.

18. The computing system of claim 1, wherein the planning data is stored on a server and a client device presents the user interface.

19. A method comprising:
presenting a set of ordered input screens that include an interview-based progression of an enterprise planning session; and
capturing planning data within the set ordered input screens.

20. The method of claim 19, further comprising presenting updated totals as a user provides the planning data throughout the enterprise planning session.

21. The method of claim 19, further comprising presenting at least one input area within the set of ordered input screens to capture a respective portion of the planning data.

22. The method of claim 21, storing the captured planning data within a data store.

23. The method of claim 19, further comprising presenting a bottom line window that presents updated totals for defined measures as a user provides the planning data throughout the enterprise planning session.

24. The method of claim 23, further comprising presenting at least one of profit, margin, and market share.

25. The method of claim 19, further comprising presenting a document window having a list of documents relevant to the enterprise planning session.

26. The method of claim 19, further comprising presenting a workflow window having a task list that sorts the enterprise planning session into planning categories.

27. The method of claim 26, further comprising presenting a corresponding series of ordered input screens for each task in the task list.

28. The method of claim 19, further comprising automatically leading the user through the set of ordered input screens throughout the enterprise planning session.

29. The method of claim 19, further comprising customizing the set of ordered input screens presented to a user based on the user's previous responses.

30. The method of claim 19, further comprising customizing the set of ordered input screens based on a type of organization or a type of user.

31. A method comprising presenting a set of ordered input screens that include an interview-based progression of an enterprise planning session.

32. A method comprising presenting an interview-based enterprise planning process that guides a user through an ordered sequence of input screens in which the user enters enterprise planning data.
